(19) United States
(12) Patent Application Publication
(10) Pub. No.: US 2025/0269742 A1
(43) Pub. Date: Aug. 28, 2025

(54) AUXILIARY BATTERY PACK FOR ELECTRIFIED VEHICLE

(71) Applicant: LACKS ENTERPRISES, INC., Grand Rapids, MI (US)

(72) Inventors: Thomas HAWKINS, Grand Rapids, MI (US); Alan FANTA, Grand Rapids, MI (US)

(73) Assignee: LACKS ENTERPRISES, INC., Grand Rapids, MI (US)

(21) Appl. No.: 19/065,139

(22) Filed: Feb. 27, 2025

Related U.S. Application Data
(60) Provisional application No. 63/558,249, filed on Feb. 27, 2024.

(51) Int. Cl. B60L 50/60; B60R 9/04; B62D 25/06; H01M 10/0525; H01M 50/209; H01M 50/211; H01M 50/249

(52) U.S. Cl. CPC B60L 50/66; B60R 9/04; B62D 25/06; H01M 10/0525; H01M 50/209; H01M 50/211; H01M 50/249; H01M 2220/20

(57) ABSTRACT

An auxiliary or secondary battery system for an electrified vehicle having a high-voltage power unit, or for electric powered and alternative fuel vehicles, such as gasoline, diesel or others, includes a structural body having an internal space defined in the electrified vehicle and a back-up battery pack placed in the internal space of the structural body and electrically connected to the high-voltage power unit. The structural body of the vehicle is at least one roof rail fixedly attached to the roof of the vehicle or a roof structure formed with a roof cavity between the exterior body and the interior body in the vehicle. The back-up battery pack is configured to selectively provide power to the high-voltage power unit for driving the electrified vehicle.

### CROSS-REFERENCE TO RELATED APPLICATIONS

This application claims priority to and the benefit of U.S. Provisional Patent Application No. 63/558,249, filed on Feb. 27, 2024, which is incorporated herein by reference in its entirety.

### FIELD

The present disclosure relates to battery packs for electrified vehicles. More particularly, the present disclosure relates to auxiliary or back-up battery packs for electric vehicles.

### BACKGROUND

The statements in this section merely provide background information related to the present disclosure and may not constitute prior art.

Due to the desire to reduce automotive fuel consumption and emissions, electrified vehicles are being developed to reduce or completely eliminate reliance on internal combustion engines. In general, the electrified vehicles differ from conventional motor vehicles because they are selectively driven by one or more battery powered electric machines. A high voltage battery pack typically powers the electric machines and other electrical loads of the electrified vehicle. The high voltage battery pack provides a limited amount of electric-only driving range.

One of the concerns among consumers considering purchasing electrified vehicles is the fear of running out of power and becoming stranded on a roadway. One way to alleviate this fear is to provide an additional battery system that can provide power to the vehicle in the event the main battery becomes drained. Accordingly, the additional battery system increases electric-only range to their electrified vehicle. Further, the additional battery system can serve another purpose to provide auxiliary power to devices or appliances inside or outside the vehicle. For example, the additional battery system can provide power to operate a lantern on a camping trip such that the primary or main battery system can be saved for driving the electrified vehicle. This can also be used to supply power for any usable need for electric powered and alternative fuel vehicles, such as gasoline, diesel or others.

U.S. Pat. No. 12,043,102 to Ruiz et al. discloses bulky battery packs that are attached to the outside of the vehicle to provide additional power (e.g., the secondary battery pack is in a cargo box, which is attached to the top of the vehicle). Placing the secondary battery in this manner on the top of the vehicle has disadvantages including increased wind resistance, lack of space for other recreational gear on the top of the vehicle, and a look that is not aesthetically pleasing. Further, it is inconvenient to remove the box in order to utilize the vehicle's roof rail system for other uses, which could necessitate the loss of the secondary battery system. Accordingly, improvements to a secondary battery system can be made that improve the consumer experience and reduces or eliminates these limitations.

### SUMMARY

The present disclosure provides needed backup (secondary) battery power by placing the battery packs in non-visible areas of the vehicle, such as within roof rails or spaces between the exterior body and interior body in the vehicle, such that the back-up battery power can be utilized for other purposes, if desired, and which provide better wind resistance by not having a large cargo box permanently on the top of the vehicle, and which are more aesthetically pleasing.

According to an exemplary form of the present disclosure, a secondary battery system for an electrified vehicle having a high-voltage power unit, or for electric powered and alternative fuel vehicles, such as gasoline, diesel or others, includes a structural body having an internal space defined in the electrified vehicle and a back-up battery pack placed in the internal space of the structural body and electrically connected to the high-voltage power unit. Further, the back-up battery pack is configured to selectively provide power to the high-voltage power unit for driving the electrified vehicle.

According to a further aspect of the present disclosure, the structural body of the electrified vehicle includes at least one roof rail securely attached to an outside surface of a roof. The at least one roof rail is formed with an elongated body portion extending between a first end and a second end. The elongated body portion of the roof rail includes a hollow cavity that defines the internal space. The back-up battery pack is arranged inside the hollow cavity of the at least one roof rail.

According to a further aspect of the present disclosure, the back-up battery pack is formed with a circular shape to be fitted inside the hollow cavity of the at least one roof rail. The back-up battery pack is formed with Li-ion cells, Li-polymer cells, or any other type of battery technology.

According to a further aspect of the present disclosure, the structural body of the electrified vehicle includes a roof cavity that defines the internal space, the roof cavity defined between an exterior body and an interior body of the roof. The back-up battery pack is arranged inside the roof cavity in the electrified vehicle.

According to a further aspect of the present disclosure, the back-up battery pack is formed with a flat prismatic shape of a pouch to be fitted inside the roof cavity of the electrified vehicle.

According to another aspect of the present disclosure, a secondary battery system for an electrified vehicle having a high-voltage power unit includes at least one roof rail attached to a roof of the electrified vehicle and a back-up battery pack arranged inside the at least one roof rail and electrically connected to the high-voltage unit. Further, the back-up battery pack is configured to selectively provide power to the high-voltage power unit for driving the electrified vehicle.

According to another aspect of the present disclosure, a secondary battery system for an electrified vehicle having a high-voltage power unit, or for electric powered and alternative fuel vehicles, such as gasoline, diesel or others, includes a roof structure having an exterior body and an interior body in the electrified vehicle and a back-up battery pack arranged in the roof structure and electrically connected to the high-voltage power unit. Further, the back-up battery pack is configured to selectively provide power to the high-voltage power unit for driving the electrified vehicle.

Further details and benefits will become apparent from the following detailed description of the appended drawings. The drawings are provided herewith purely for illustrative purposes and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a perspective view of a roof rack assembly that is secured to a roof in an electrified vehicle or for electric powered and alternative fuel vehicles, such as gasoline, diesel or others, in accordance with an exemplary form of the present disclosure;

FIG. 2 is a transparent view of a roof rail having an auxiliary or back-up battery pack inside a hollow cavity of the roof rail;

FIG. 2A is a cross sectional view of the roof rail, taken along line 2A-2A of FIG. 2; and

FIG. 3 shows an exploded view of a roof structure having an auxiliary or back-up battery pack in the electrified vehicle or for electric powered and alternative fuel vehicles, such as gasoline, diesel or others, in accordance with another exemplary form of the present disclosure.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. It should be understood that throughout the drawings, corresponding reference numerals indicate like or corresponding parts and features.

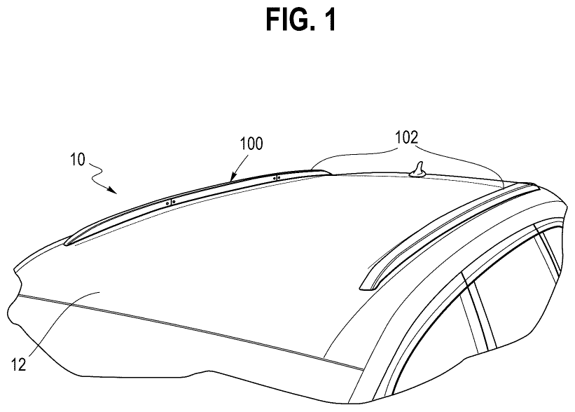

FIG. 1 shows a roof rack assembly 100 mounted along a roof 12 for storing or transporting items in an electrified vehicle 10. Although depicted as an electric vehicle (EV) below, it should be understood that the concepts described in the present disclosure are not limited to EVs and could extend to other electrified vehicles including, but not limited to, hybrid electric vehicles (HEVs), plug-in hybrid vehicles (PHEVs), fuel cell vehicles, etc. Further, the system of the present disclosure can also be used to supply power for any usable need for electric powered and alternative fuel vehicles, such as gasoline, diesel or others.

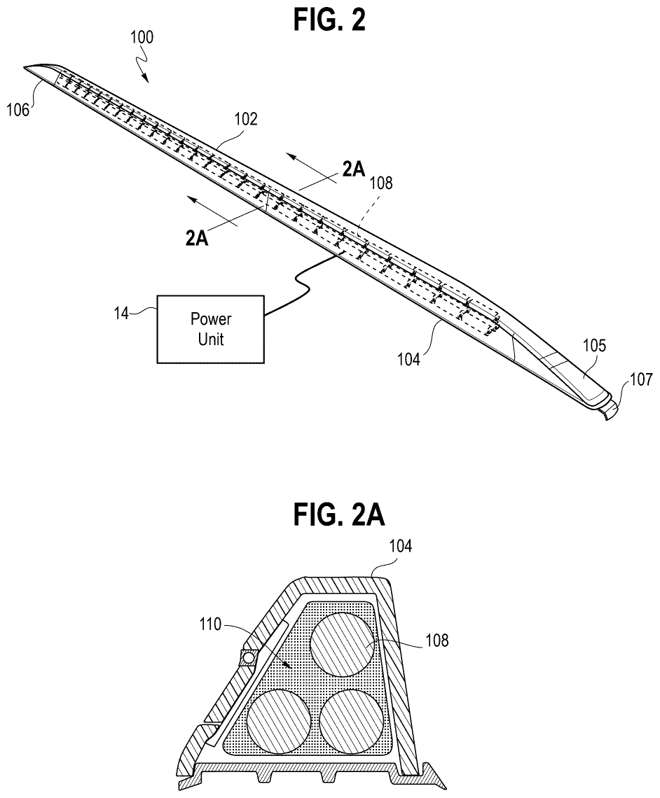

As shown in FIG. 1, typically, the roof rack assembly 100 of the vehicle 10 includes a pair of roof rails 102 that extend along respective sides of the roof 12 in spaced and relatively parallel relationship with one another. For example, the roof rail 102 may include an elongated body portion 104 that extends between a first end 105 and a second end 106. Further, the roof rail 102 includes a connecting portion 107 (see FIG. 2) coupled to each of the first and second ends 105 and 106 to attach the roof rail 102 to the roof 12 of the vehicle 10. In another approach, the connecting portion 107 may be integrally formed with the elongated body portion 104 of the roof rail 102 as a single unit. The connecting portion 107 is the region at which the roof rail 102 is secured to the roof 12 of the vehicle 10, such that the connecting portion 107 of the roof rail 102 is fixedly attached to the roof 12 of the vehicle 10 by fastening mechanisms such as screws, adhesive materials, etc.

Further, the electrified vehicle 10 generally includes a primary or main battery pack providing power to generate torque to drive one or more sets of vehicle drive wheels (not shown). The primary or main battery pack may be a high voltage battery that includes a plurality of battery arrays (i.e., groupings of battery cells) capable of outputting electrical power to operate the motor, the generator, and/or other electrical loads of the electrified vehicle 10 for providing power to propel the wheels (not shown). In another approach, other types of energy storage devices and/or output devices could also be used to electrically power the electrified vehicle 10.

FIG. 2 shows an auxiliary (secondary) or back-up battery pack 108 placed inside the elongated body portion 104 of the roof rail 102, and FIG. 2A shows a cross-sectional view of the roof rail 102 having the back-up battery pack 108. The elongated body portion 104 of the roof rail 102 includes a hollow cavity 110 to store the back-up battery pack 108, which is electrically connected to a high-voltage power unit in the vehicle 10. Accordingly, the back-up battery pack 108 can provide power when the primary or main battery becomes drained in the vehicle 10. Further, the roof rails 102 may be made of a molded resin material, such as PC/ABS, ABS, nylons, TPO, various other thermoplastic materials, etc. to have the hollow cavity 110, which is defined as a space to store the back-up battery pack 108 in the roof rail 12. In another approach, however, the roof rail 102 may also be formed of other materials, such as carbon fiber, or a metallic material or alloy, such as aluminum, steel, titanium, zinc, various other alloys, etc. In one aspect, the roof rails 102 may be plated or coated, such as with chrome, paint, or other layers to provide UV or corrosion resistance, or for decorative/appearance reasons. The selection of material for the roof rails 102 may depend on particular design needs for the intended vehicle type, trim level, expected use, etc. The space in which the battery pack 108 is disposed, such as the hollow cavity 110, may also be referred to generally as an internal space, such that the hollow cavity 110 defines the internal space in this embodiment.

The auxiliary or back-up battery pack 108 may be an additional high voltage battery provided on the electrified vehicle 10. The back-up battery pack 108 is also capable of outputting electrical power for driving the motor of the vehicle 10. Also, the back-up battery pack 108 may be electrically connected to an inverter supporting bidirectional power flow by converting direct current from the back-up battery pack 108 to alternating current for powering the motor. Accordingly, the primary or main battery pack (not shown) and the back-up battery pack 108 can be controlled to provide power for driving the motor of the vehicle 10.

Further, the electrified vehicle 10 may also be equipped with a charging system (not shown) for charging the energy storage devices (e.g., battery cells) of the primary battery pack and the back-up battery pack 108. The charging system may include charging components that are located both onboard the electrified vehicle 10 and external to the electrified vehicle 10. The charging system can be connected to an external power source for receiving and distributing external power source throughout the electrified vehicle 10.

As shown in FIG. 2, the back-up battery pack 108 may be some form of Li-ion, Li-polymer battery, or any other type of battery technology. These batteries offer greater power densities compared to other battery chemistries and also are the same chemistry as that used in the main battery pack of the electrified vehicle 10. The back-up battery pack 108 may have a plurality of battery cells that store energy for powering various electrical loads of the electrified vehicle 10. In FIGS. 2 and 2A, for example, the battery cells of the back-up battery pack 108 may be formed with a cylindrical shape to be placed into the hollow cavity 110 of the long-extended roof rails 102. The cylindrical battery cells of the back-up battery pack 108 have a hard casing on the outside and the battery component films are rolled and then placed in the cylindrical casing, which are wound cells due to the fact the films are rolled into a cylinder before placing them in the container. As shown in FIG. 2, the battery cells of the back-up battery pack 108 may be stacked along the extended body portion 104 of the roof rail 102. The back-up battery pack 108 could employ any shape of battery cells within the scope of the present disclosure. Thus, this disclosure is not limited to the particular shape shown in FIGS. 2 and 2A.

In another approach, the back-up battery pack 108 may be formed with prismatic cells, which are shaped like rectangular prisms and the component films are cut to shape and stacked together. Depending on the specific chemistry of the battery, the cells can have either a hard casing which is typical of Li-ion cells, or a soft bag or pouch casing which is typical of Li-polymer batteries. However, the battery cells having other shapes (e.g., cylindrical, pouch, etc.), other chemistries (nickel-metal hydride, lead-acid, etc.), or both could alternatively be utilized within the scope of the present disclosure.

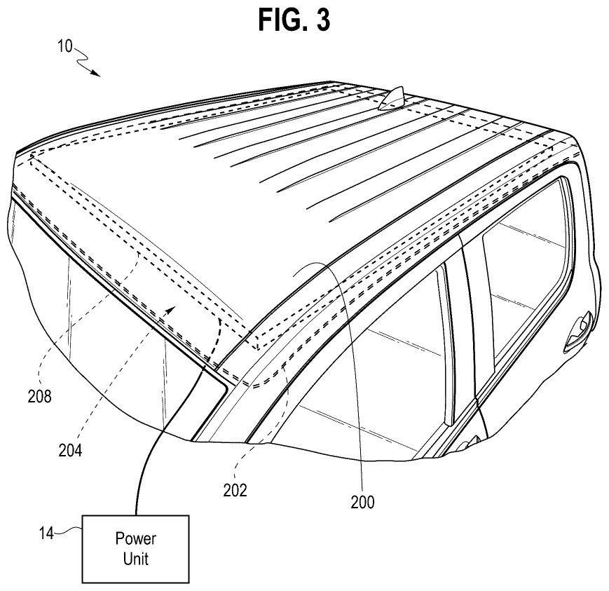

According to another exemplary embodiment of the present disclosure, FIG. 3 shows an exploded view of the roof structure of the electrified vehicle 10. The roof structure of the vehicle 10 includes an exterior body 200 and an interior body 202 formed as a ceiling of the passenger compartment. Further, the electrified vehicle 10 may have a roof cavity 204 defined as a space between the exterior body 200 and the interior body 202 to place the back-up battery pack 208 inside the roof structure of the vehicle 10. Further, the back-up battery pack 208 is electrically connected to the high-voltage power unit 14 for providing power when the primary or main battery becomes drained in the vehicle 10.

In FIG. 3, the back-up battery pack 208 stored in the roof cavity 204 is formed with a flat prismatic or pouch, but is not limited to the shape of the back-up battery pack 208 to be placed into the roof cavity 204. The space in which the battery pack 208 is disposed, such as the roof cavity 204, may also be referred to generally as an internal space, such that the roof cavity 204 defines the internal space in this embodiment.

Further, the roof cavity 204 defined between the exterior body 200 and the interior body 202 may be designed with an expanded cavity to place the back-up battery pack 208 having more capacity. A series of pouch batteries could conform to the curved shape of the roof structure of the vehicle 10. The prismatic cells with hard casings may stack efficiently in a rectangular space defined in the vehicle 10. Further, the soft pouch battery cells may have a degree of flexibility and conform to a shape with some degree of curvature. Accordingly the shape of the back-up battery pack 108 may be determined based on factors such as degree of curvature in the vehicle structure and also the manufacturing cost of the battery cells.

As shown in FIGS. 2 and 3 of the present disclosure, the back-up battery packs 108 and 208 providing auxiliary power for the electrified vehicle 10 may be placed inside the internal spaces formed in the vehicle structure, such as the hollow cavity 110 of the roof rail 102 and the roof cavity 204 between the exterior body 200 and interior body 202 of the roof. The electrified vehicle 10 thereby may have internal spaces where the back-up battery pack 108/208 may be placed that is hidden from view. As shown in FIG. 3 and described above, for example, the electrified vehicle 10 may have the internal spaces defined between the exterior body 200 and the interior body 202 of the roof structure to place the back-up battery pack 208 inside the roof cavity 204 of the vehicle 10.

According to another aspect of the present disclosure, the vehicle body may have other internal spaces where the back-up battery pack may be placed. For example, a sleeve or shelf under the hood or rear trunk lid in the electrified vehicle could store either cylindrical or prismatic back-up battery packs (not shown). In another approach, the back-up battery pack 108/208 may be placed in vertically oriented structures such as rear hatch back doors or side doors of the vehicle, or within the structural pillars of the vehicle body including the A-pillar, B-pillar, C-pillar. Further, the placement of the back-up battery packs 108/208 may be not limited to the area described above, but may include other areas of the electrified vehicle that are hidden from the view of the user.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A secondary battery system for an electrified vehicle having a high-voltage power unit, or for electric powered and alternative fuel vehicles, such as gasoline, diesel or others, the secondary battery system comprising:
a structural body having an internal space defined in the electrified vehicle; and
a back-up battery pack placed in the internal space of the structural body and electrically connected to the high-voltage power unit,
wherein the back-up battery pack is configured to selectively provide power to the high-voltage power unit for driving the electrified vehicle.

2. The secondary battery system of claim 1, wherein the structural body of the electrified vehicle includes at least one roof rail securely attached to an outside surface of a roof.

3. The secondary battery system of claim 2, wherein the at least one roof rail is formed with an elongated body portion extending between a first end and a second end.

4. The secondary battery system of claim 3, wherein the elongated body portion of the at least one roof rail includes a hollow cavity that defines the internal space in the electrified vehicle.

5. The secondary battery system of claim 4, wherein the back-up battery pack is arranged inside the hollow cavity of the at least one roof rail.

6. The secondary battery system of claim 5, wherein the back-up battery pack is formed with a circular shape to be fitted inside the hollow cavity of the at least one roof rail.

7. The secondary battery system of claim 5, wherein the back-up battery pack is formed with Li-ion cells, Li-polymer cells, or any other type of battery technology.

8. The secondary battery system of claim 1, wherein the structural body of the electrified vehicle includes a roof cavity that defines the internal space between an exterior body and an interior body of a roof of the electrified vehicle.

9. The secondary battery system of claim 8, wherein the back-up battery pack is arranged inside the roof cavity of the electrified vehicle.

10. The secondary battery system of claim 9, wherein the back-up battery pack is formed with a flat prismatic shape or a pouch to be fitted inside the roof cavity of the electrified vehicle.

11. The secondary battery system of claim 9, wherein the back-up battery pack is formed with Li-ion cells, Li-polymer cells, or any other type of battery technology.

12. A secondary battery system for an electrified vehicle having a high-voltage power unit, or for electric powered and alternative fuel vehicles, such as gasoline, diesel or others, the secondary battery system comprising:
at least one roof rail securely attached to a roof of the electrified vehicle; and
a back-up battery pack arranged in the at least one roof rail and electrically connected to the high-voltage power unit,
wherein the back-up battery pack is configured to selectively provide power to the high-voltage power unit for driving the electrified vehicle.

13. The secondary battery system of claim 12, wherein the at least one roof rail includes an elongated body portion extending between a first end and a second end, and a hollow cavity formed in the elongated body portion.

14. The secondary battery system of claim 13, wherein the back-up battery pack is arranged inside the hollow cavity of the at least one roof rail.

15. The secondary battery system of claim 14, wherein the back-up battery pack is formed with a circular shape to be fitted inside the hollow cavity of the at least one roof rail.

16. The secondary battery system of claim 14, wherein the back-up battery pack is formed with Li-ion cells, Li-polymer cells, or any other type of battery technology.

17. A secondary battery system for an electrified vehicle having a high-voltage power unit, or for electric powered and alternative fuel vehicles, such as gasoline, diesel or others, the secondary battery system comprising:
a roof structure having an exterior body and an interior body in the electrified vehicle; and
a back-up battery pack arranged in the roof structure and electrically connected to the high-voltage power unit,
wherein the back-up battery pack is configured to selectively provide power to the high-voltage power unit for driving the electrified vehicle.

18. The secondary battery system of claim 17, wherein the roof structure includes a roof cavity defined between the exterior body and the interior body in the vehicle.

19. The secondary battery system of claim 18, wherein the back-up battery pack is formed with a flat prismatic shape or a pouch to be fitted inside the roof cavity.

20. The secondary battery system of claim 19, wherein the back-up battery pack is formed with Li-ion cells, Li-polymer cells, or any other type of battery technology.
